(19) United States
(12) Patent Application Publication
(10) Pub. No.: US 2024/0382824 A1
(43) Pub. Date: Nov. 21, 2024

(54) VIDEO STREAM SWITCHING FOR LIVE GAMING OPERATIONS

(71) Applicant: Interblock d.o.o., Las Vegas, NV (US)

(72) Inventor: John Joseph Connelly, Las Vegas, NV (US)

(21) Appl. No.: 18/390,109

(22) Filed: Dec. 20, 2023

Related U.S. Application Data
(60) Provisional application No. 63/504,466, filed on May 26, 2023.
(60) Provisional application No. 63/502,811, filed on May 17, 2023.

(51) Int. Cl. A63F 3/00; A63F 13/86; G07F 17/32; H04N 21/2187

(52) U.S. Cl. CPC A63F 3/00157; A63F 13/86; G07F 17/3209; G07F 17/3288; H04N 21/2187; A63F 2001/003

(57) ABSTRACT

The present disclosure relates to systems and methods for live gaming and video stream switching. Various embodiments may stream a video output from a camera to a display associated a user device. Player input at the user device may update the video output, and when the updated video corresponds to a gaming region on a play station, video output from the play station may be streamed to the user device. The play station video output may correspond to a live game, and the live game may be operated based on input from the user device.

### CROSS-REFERENCE TO RELATED APPLICATIONS

The present application claims a right to priority to U.S. Patent Application No. 63/504,466, filed May 26, 2023, and U.S. Patent Application No. 63/502,811, filed May 17, 2023, the entireties of each of which are incorporated by reference herein.

### TECHNICAL FIELD

The present disclosure relates generally, but not exclusively, to the field of gaming, particularly live gaming systems.

### BACKGROUND INFORMATION

Casinos offer a variety of games to attract players. Such games may include live table games (e.g., roulette, craps, blackjack, etc.), virtual games, physical machines (e.g., slot machines), individual play stations, stadium-style group stations, and various gameplay combinations. Traditionally, players must physically go to a casino or the gaming location to participate. However, this may not always be possible, and when players are unable to play at a casino, the casino does not receive the business and the player misses out on the gaming experience.

Although online gaming platforms provide one way for players to remotely participate in casino games and other gaming events, the online experience is very different than in-person and live gaming events at an actual location. Many players enjoy playing at a particular casino or gaming location, or a particular machine, and online gaming platforms cannot provide a comparable experience and familiarity.

Additionally, players have many game types, options, and platforms available. Casinos and gaming providers must continuously innovate to attract and retain players, maintain profitability, and improve player experience.

### SUMMARY

An embodiment is directed to a method for live gaming. A camera may stream video output to a display associated with a user device. The video output captures a first field of view comprising a play station and/or a play area. The user device receives player input to update the video output to a second field of view, and the second field of view may be within the first field of view. After determining that the second field of view corresponds to a gaming area on the play station, video output corresponding to a live game may be streamed from the play station to the display associated with the user device. The user device may then operate the live game based on received user input. According to some examples, the user device may stop streaming video output from the camera after a determination that the gaming area or a selected region corresponds to a gaming screen. In other examples, along with the video output, gameplay control from the play station transfers to the user device.

Another embodiment may include a camera capturing a gaming area, a play station, and an application operating on a user device. The user device may include at least one of a phone, a personal computer (PC), or a gaming device. The play station may be an electronic table game. An external controller may connect to the user device to perform one or more gameplay operations. The external controller may connect to the user device via a Universal Serial Bus (USB).

Other embodiments include techniques for streaming live gaming events and providing remote gaming. In an example, video output may be streamed from a camera to a display associated with a user device. The video output may capture a first field of view comprising a live gaming event at a gaming location, such as a casino. A user device may provide a wager indicative of a predicted outcome of a game cycle associated with the live gaming event. An action performed by a player or dealer may initiate the game cycle. The outcome of the game cycle may be streamed, in real-time, to the user device, and the wager may be resolved based on the outcome of the game cycle.

These and other features will be more clearly understood from the following detailed description taken in conjunction with the accompanying drawings and claims. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a diagrammatic, elevated view of a wagering system in accordance with an embodiment.

FIG. 2 illustrates an example graphical user interface (“GUI”) displayed by a play station, in accordance with an embodiment.

FIG. 3 is a diagrammatic, top view of gaming in a stadium configuration, in accordance with an embodiment.

FIG. 4A illustrates an interactive gaming floor video feed, in accordance with an embodiment.

FIG. 4B illustrates live gaming on a user device, in accordance with an embodiment.

FIG. 5 is a flowchart for live gaming operations, in accordance with an embodiment.

FIG. 6 is an illustration of an exemplary block diagram representing a general purpose computer system in which aspects of the methods and systems disclosed herein or portions thereof may be incorporated.

### DETAILED DESCRIPTION OF EMBODIMENTS

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

Disclosed herein are methods, systems, and computer readable storage media that provide video stream switching techniques for live gaming operations. According to various aspects, players may interact with a smartphone or other user device to view a gaming area, interact with a gaming station, and play live gaming events. A live video stream may provide live action gaming views and/or gaming floor views. Players may select a gaming machine, such as a play station, or participate in a live game, based on selections at the device. In some examples, a player may zoom in on a play station, and when the play station screen fills the view of the player device, the video stream may switch to the video output of the player screen.

Such techniques may provide seamless transitions between live gaming floor views and live gaming events. Aspects enable players to have additional control and customization of their overall gaming experience gaming. This may lead to increased player interest and entertainment during the gaming, and improved player experiences can result in increased play and profitability.

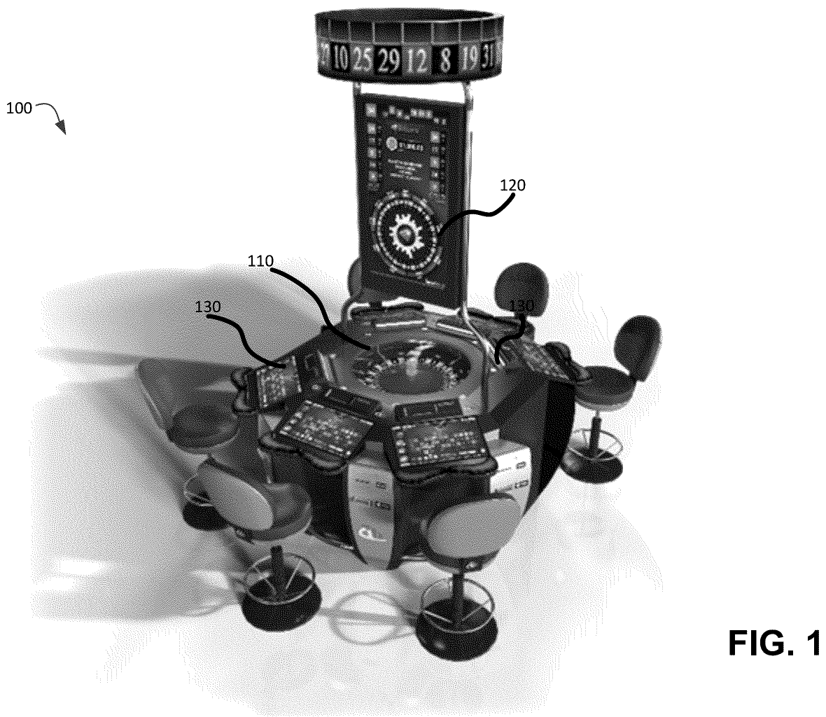

FIG. 1 illustrates a live gaming system 100 in accordance with various aspects of the present disclosure. As shown by FIG. 1, the live gaming system 100 may be, for example, an automated roulette wagering system including a roulette machine 110, a central display 120, and a plurality of play stations 130. While six play stations 130 are illustrated in the embodiment depicted by FIG. 1, one skilled in the art will recognize that live gaming system 100 may include a single play station or any number of play stations.

For example, the live gaming system 100 may include one play station, two play stations, ten play stations, and so on. In an embodiment, the live gaming system 100 may not include any play stations 130. For example, live gaming system 100 may be servicing one or more remote clients or user devices not physically proximate to the live gaming system 100. That is, roulette machine 110 of live gaming system 100 may be an unattended live table game of chance providing game cycle results to one or more play stations physically remote from roulette machine 110. In an embodiment, the live gaming system 100 may be servicing a combination of local play stations (e.g., play stations 130) and remote play stations. And, while a roulette machine is illustrated, any type of electronic gaming machine may be utilized, including slot machines, dice systems for craps or sic bo and card systems for poker, blackjack, baccarat, pai gow poker, etc.

In an embodiment, the live gaming system 100 is located at a first geographic location and is providing game cycle results to remote clients physically located at one or more remote geographic locations that are not physically proximate to the first geographic location. For example, the live gaming system 100 may be located in a warehouse and provide game cycle results to remote clients located in a casino a few miles away from the warehouse, or at home, or while moving about. As another example, the live gaming system 100 may be located in a first casino and provide game cycle results to remote clients located in a second casino or gaming establishment or elsewhere. The first casino and the second casino or gaming establishment may be located in a different city, state, country, etc.

Roulette machine 110 is configured to operate unattended live roulette games in which a physical roulette ball is launched into an angled annular track encircling a roulette wheel. In an embodiment, roulette machine 110 may be configured to operate any known live table game of chance. Each live roulette game operated by roulette machine 110 is composed of a game cycle. The game cycle of the live roulette game begins as a roulette ball is positioned to be launched into the annular track. The roulette ball is launched into the annular track and rotates around the annular track a plurality of times. In an embodiment, the roulette ball is rotated around the annular track in a first direction and the roulette wheel is spinning about a central axis in a second direction opposing the first direction. Friction between the roulette ball and the annular track reduces a momentum of the roulette ball until gravity causes the roulette ball to exit the annular track.

Upon exiting the annular track, the roulette ball follows a path towards the center of the roulette wheel along a downward slope intervening between the annular track and the roulette wheel. As the roulette ball follows the path towards the center of the roulette wheel, the roulette ball may interact with one or more ball stops positioned about the downward slope. When the roulette ball encounters the roulette wheel, the roulette ball bounces a plurality of times and then settles into one of a plurality of ball slots positioned around an outer circumference of the roulette wheel. The game cycle concludes as the roulette ball settles in one of the plurality of ball slots. A game cycle outcome is determined based on a number and possibly also a color corresponding to the particular ball slot in which the roulette ball settled.

Each live roulette game operated by roulette machine 110 is also composed of a betting window associated with the game cycle. The betting window includes a bet open time and a bet close time. The bet open time represents a point in time in which the betting window transitions from a closed state to an open state. After the bet open time, the betting window is in the open state and a player is allowed to place one or more bets or wagers on the associated game cycle. In an embodiment, the player is allowed to place one or more side bets or wagers on at least one additional game of chance when the betting window is in the open state.

The bet close time represents a point in time in which the betting window transitions from an open state to a closed state. After the bet close time, the betting window is in the closed state and the player is no longer allowed to place bets or wagers on the associated game cycle. In an embodiment, the bet close time precedes a time that the roulette ball settles in one of the plurality of ball slots. In an embodiment, the bet close time precedes a time that the roulette ball exits the annular track. In an embodiment, the bet close time is adjustable based on an inertial value associated with the roulette ball.

In operation, the electronic gaming machines, including roulette machine 110, utilize one or more random number generators to control various mechanical aspects of the game play, including live roulette games. The one or more random number generators are used to increase a randomization of events composing the games. Increasing the randomization of events composing the games reduces a likelihood that game cycle results are predictable. For example, random number generators may dictate a velocity that a roulette ball is launched into the angled annular track by the roulette machine 110, a number of times that a roulette ball rotates around the angular track, a direction the roulette ball spins while rotating around the angular track, a timing of various events composing the live roulette games, and the like.

Central display 120 is configured to present players and other guests of the casino or other gaming establishment with information associated with the live roulette games operated by roulette machine 110. Such information may be presented in a visual format, an auditory format, or a combination thereof. The information presented by central display 120 may include information regarding individual results of previous game cycles, a state of a current betting window associated with roulette machine 110, statistics about previous games cycles, an operating condition of roulette machine 110, a progressive jackpot associated with roulette machine 110, and the like. In an embodiment, central display 120 is further configured to present players and other guests of the casino or other gaming establishment with advertising media.

Each play station among the plurality of play stations 130 is generally configured to enable a player to participate in the live roulette games operated by roulette machine 110. In an embodiment, each play station among the plurality of play stations 130 is further configured to enable the player to participate in at least one additional game of chance. In an embodiment, the at least one game of chance is operated by a gaming device other than roulette machine 110. For example, a play station 130 may enable the player to fund a credit balance for placing bets, place bets on games of chance (e.g., the live roulette game operated by roulette machine 110), receive winnings associated with bets placed on games of chance, and the like. In an embodiment, a play station may enable the player to interact with an object associated with a game of chance. Examples of such objects include dice, a ball, a wheel, and the like.

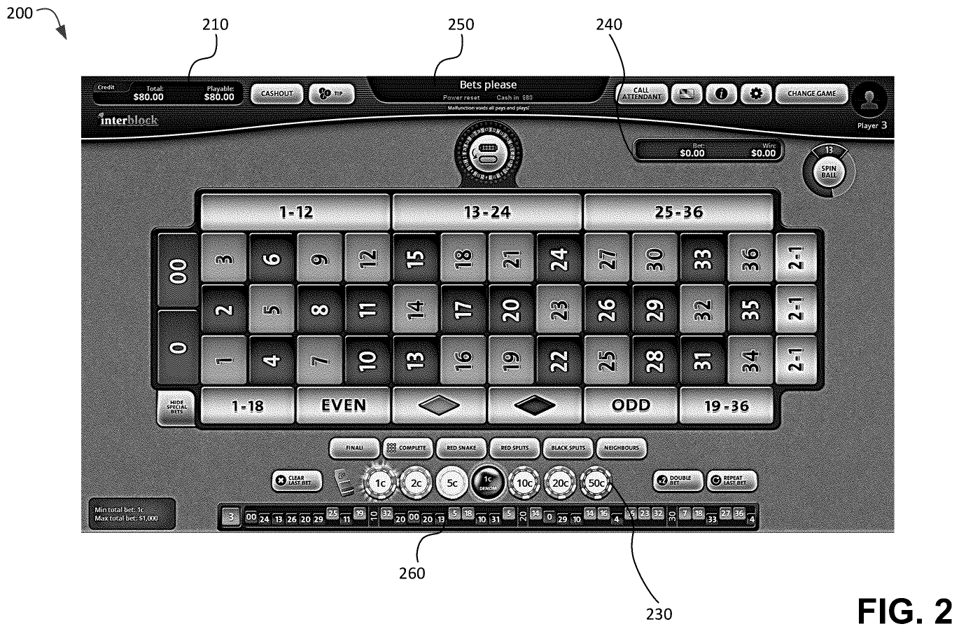

As best seen in FIG. 2, play station 130 may present a graphical user interface (“GUI”) 200 that enables a player to participate in the live roulette games operated by roulette machine 110. For example, GUI 200 may display account information 210 to a player that represents a maximum credit balance that is available to the player for wagering on the live roulette games. In an embodiment, a player may insert currency, tickets, tokens, and the like into play station 130 in order to increase the maximum credit balance. In an embodiment, a player may electronically transfer funds from another account using play station 130 in order to increase the maximum credit balance.

GUI 200 may also display an electronic representation of a felt betting area 220 (or layout) for live roulette games operated by roulette machine 110 or some other electronic representation for any other type of game. The player may wager on the live roulette games by placing one or more virtual chips 230 onto the felt betting area 220. For example, the player may place virtual chips 230 onto an area of felt betting area 220 that identifies a particular ball slot in which the player believes a roulette ball will come to rest within a particular game cycle. As another example, the player may place virtual chips 230 onto an area of felt betting area 220 that identifies a particular range of ball slots in which the player believes a roulette ball will come to rest. The player may also place virtual chips 230 onto felt betting area 220 to bet that during a particular game cycle a roulette ball will come to rest in a ball slot associated with a particular color (e.g., red or black). As another example, the player may also place virtual chips 230 onto felt betting area 220 to bet that a roulette ball will come to rest in a ball slot associated with an odd or even number.

A wagering update area 240 of GUI 200 may also present information regarding an amount currently wagered by the player on the live roulette games operated by roulette machine 110. Information regarding a payout amount won by the player through previous bets may also be presented to the player in wagering update area 240. In an embodiment, wagering update area 240 may also present the player with information regarding an aggregate amount wagered and/or won in a current session. In an embodiment, wagering update area 240 may also present the player with information regarding an aggregate amount wagered and/or won within a predetermined period of time (e.g., hour, day, month, year, lifetime, etc.).

GUI 200 may also present a status update area 250 that provides the player with information about a current game cycle of the live roulette games operated by roulette machine 110. For example, status update area 250 may inform the player that a betting window associated with the current game cycle is in an open state. The betting window is in the open state between a bet open time and a bet close time. As long as the betting window remains in the open state, the player is free to wager on the current game cycle of the live roulette games. The betting window associated with the current game cycle transitions from the open state to a closed state when the bet close time is reached. Status update area 250 may inform the player that a betting window associated with the current game cycle is in the closed state.

A historical data area 260 of GUI 200 may provide the player with information about results from previous game cycles of the live roulette games. For example, historical data area 260 may display a sequence of individual results from the previous game cycles. As another example, historical data area 260 may display statistical information about the previous game cycles. The statistical information may include a percentage of a predetermined number of previous game cycles in which the roulette ball came to rest in a particular color, a ball slot associated with an odd number, a particular range of ball slots, and the like.

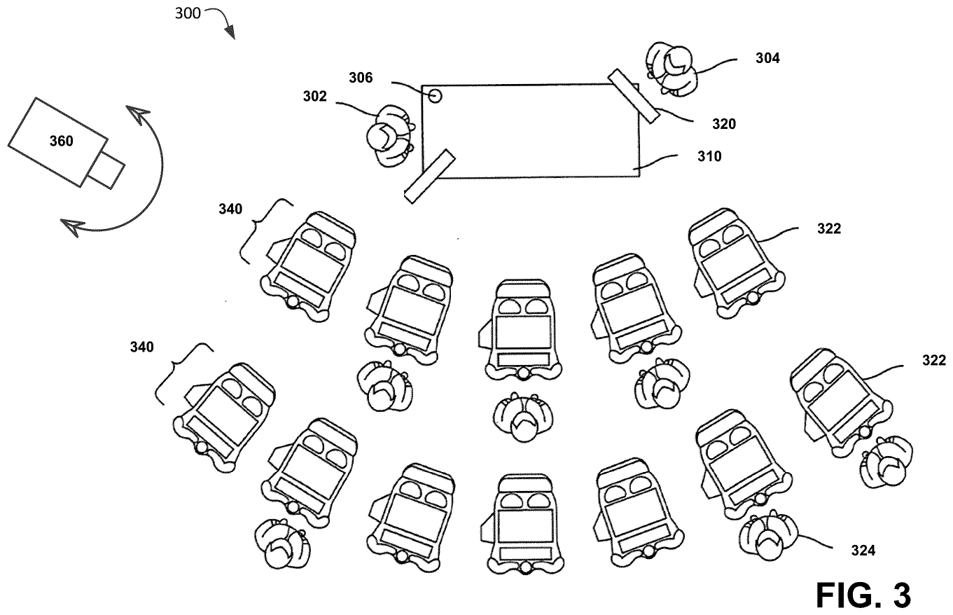

FIG. 3 illustrates a live table gaming set up in a stadium configuration. While live gaming table 310 illustrates a craps table, the live gaming table may provide a platform for a variety of in-person and remote betting and casino games, including but not limited to craps, roulette, blackjack, as well as a variety of slot machines that may be played live, i.e., physically played in a physical environment while play is controlled remotely by a player. The live table game may be incorporated with one or more play stations 340, and/or with any of the gaming examples discussed herein regarding FIGS. 1 and 2. One or more cameras 360 may provide video output of the gaming area 300 or the machine. The gaming area 300 may include any or all of the live gaming table 310 and the play stations 340. As discussed herein, the video output may be streamed to a player device, such as a remote player device or play station. In some examples, input at the player device may adjust the camera's video, for example, causing a closer view or zoomed in view of a particular play station 340, the live gaming table 310, a machine, or other object within the gaming area 300, or adjust the cameras' fields of view, angle or which camera is streaming video output.

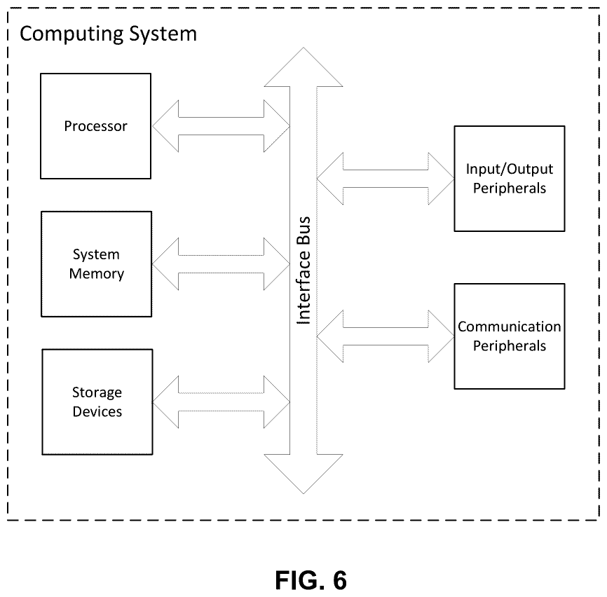

Various aspects may include at least one image sensor. The at least one image sensor 370 is configured to capture image data associated with particular game cycles of the games played at a play station 340. Image sensor may provide the captured image data to a controller associated with the camera 360 as a video stream, a sequence of individual image frames, raw image data, and the like. In an embodiment, a controller (in the form of a computer system, see e.g., FIG. 6) associated with the play station 340 and/or user device may configure the image sensor by specifying a frame-rate, a resolution, a color value, a video stream encoding format, a subset of the image sensor's available pixels to activate and/or deactivate, and the like.

In some examples, the camera 360 may include an image sensor configured to capture image data on a continuous basis. For example, image data captured by image sensor may provide a live video feed of the live games operated at gaming table 310 or on machines. In an embodiment, the camera may capture image data for a predefined period of time, such as a particular game cycle. For example, such predefined periods may be associated with a dice roll, roulette ball launch, a roulette ball landing result, a slot roll, a betting window associated with a particular game, or another event occurring at gaming table 310.

In an embodiment, the image sensor is configured to capture image data associated with a particular area of the gaming table 310 or machine. For example, if a roulette wheel were located at the gaming table area, the particular area may include a launch point, an arc portion of annular track, a predefined reference point of roulette wheel, a table stop position of roulette wheel, and the like.

In one example, the live gaming table 310 is a typical craps table on which a layout is displayed, and on which dice can be rolled by a shooter 302. A single dealer 304, called a “croupier,” may be positioned at an end of the table opposite the shooter. The dealer may call a player to step up to the table 310 and roll the dice. Once a player steps up to the table 310 to become the shooter, the croupier may walk over and place five dice in a dice area 306 on the table near the shooter 302. Alternatively, the croupier may act as a stickman to control the dice. For example, the croupier may use a long stick 320 to push five dice into the dice area 306. Once the shooter 302 has selected two dice to shoot, the remaining three dice are removed.

According to various embodiments, the gameplay occurring on the table 310 initiates a gaming cycle, such as a round of play, and the gameplay may be reflected on a play station 340, a player device, or both. An action taken by a live player or dealer may initiate a gaming cycle on which remote and/or local players wager. In a craps example, a shooter 302 may initiate the gaming cycle when the dice are thrown on table 310, and the outcome of the gaming cycle corresponds to the dice roll outcome. The gaming cycle outcome may be automatically determined, for example using a dice recognition system. In other examples, the dealer 304 may determine and record the gaming cycle outcome.

A screen 322 of a play station or player device may reflect various aspects of gameplay and/or results from the live game happening on table 310. A player 324 may interact with the gaming station 340 or player device, and place bets based on the live gameplay, or otherwise provide control input.

In some examples, the screen 322 on a player device is an interactive touch screen, and may provide one or more gaming displays. The gaming displays may be associated with the live gaming table 310. The screen 322 or player device may also provide gaming information separate from the live gameplay at table 310.

Gaming events occurring at gaming table 310 may be live streamed to one or more remote user devices, and remote players can wager on the gaming event, similar to local players wagering in person or on a play station. Remote players may wager, for example, on various actions and/or outcomes occurring at the gaming table 310. In a dice game, such as craps or sic-bo, for example, remote players may wager on a predicted outcome of a dice roll, a combination of rolls, or any other aspect related to the dice game. In a roulette game using one, two, or more roulette wheels, players may wager on a predicted outcome of a wheel spin, or any of a combination of wheel spins and sequences. In a card came, such as poker or blackjack, players may wager on a card draw, a final hand, a round of play, or any other aspect related to the card game. In addition to dice games, roulette games, and card games, other types of games may be applicable, including but not limited to games requiring a live player and/or dealer.

In some examples, an application, web-based platform, or other interactive user interface provides a gaming interface for remote users to enter wagers and participate in the gaming event. In other examples, the gaming interface may concurrently provide a live video stream of the gaming event, and an area to place wagers. The interactive user interface may be customizable, thereby enabling remote players to personalize their remote gameplay experience.

In some embodiments, the live stream may be provided via camera 360, and remote players may adjust their field of view. For example, remote players may switch between two or more cameras within the gaming location, toggle between different views of the gaming area 300, zoom in, zoom out, and/or adjust an area of focus. In another example, a user, via the user device, may change the field of view of the video output to focus on a particular area of the live gaming event. The field of view may also be changed to focus and/or zoom in on a gaming area associated with a play station.

As described herein, one or more play stations at the gaming location may be associated with the live gaming event and provide a gaming interface for local players to wager and/or participate the live gaming event. Remote players may also interact with such play stations through selections at the user device. By zooming in, or otherwise selecting a particular play station, the gaming interface from the play station may be provided on the user device. In an example, embodiments may determine that the field of view at the user device corresponds to a gaming area on a play station, and in response, stream video output from the play station to the user device.

Although a stadium configuration is illustrated, any of a plurality of gaming configuration and play station configurations may apply and utilize various features and embodiments discussed herein. Such techniques allow remote players to participate in slive gaming events and choose a preferred play station, as if the player were playing at the gaming location. As such, both local and remote players may wager, watch, and participate in the same live gaming event. These techniques improve player accessibility and enable greater participation and potential profits than local or remote gaming alone.

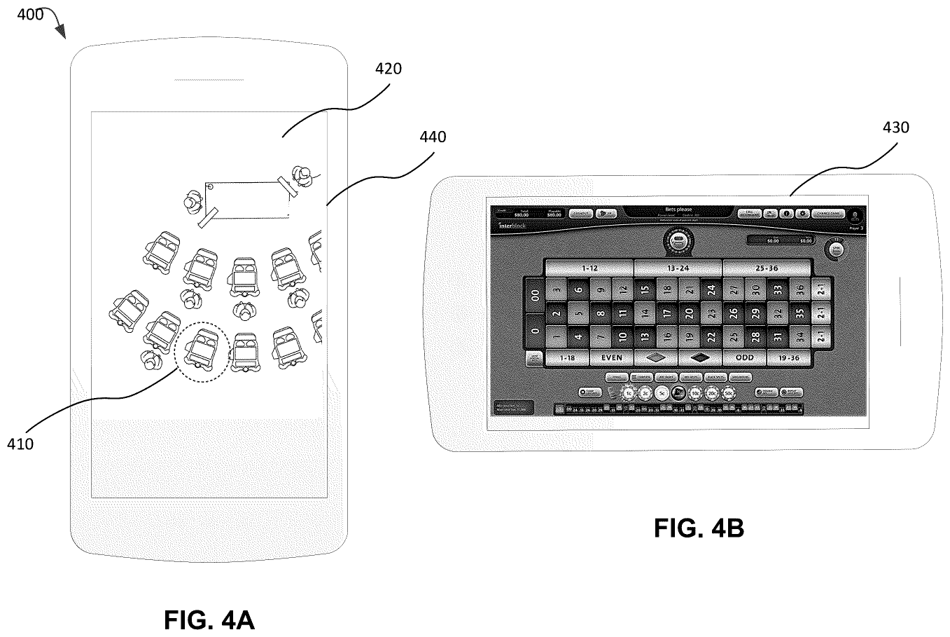

FIGS. 4A and 4B illustrate interactive gaming and video stream switching techniques occurring at a player device 400. In FIG. 4A the player device may display a scene 420 associated with video of the gaming area 300 captured by at least one camera 360 or image sensor. FIG. 4B illustrates an interactive gaming screen 430 which may be streamed following a selection 410 of a gaming station. While FIG. 4A illustrates astadium-style, live craps table environment and FIG. 4B illustrates a betting layout for a roulette game, the point is that whatever is displayed in one environment can start with a broader view of the overall gaming environment and continue to zoom in until only a certain portion of a display of a play station 340 is displayed on the gaming screen 430.

As illustrated in FIG. 4A, a scene 420 may be streamed to a player or user device. In various embodiments, the user device is at least one of a phone, a smartphone, a tablet, a personal computer, or a gaming device. In some examples, the scene 420 may be manipulated using a screen tap, voice-command, motion, selection, or other interactive device, such as a stylus, mouse, controller, or other peripheral. A player may zoom in or out of the scene 420 based on a pinching motion bringing two fingers together or apart to control the zoom level. In other examples, a user may tap the screen (e.g., single tap, double tap, multi-tap, short press, long press, etc.) at the desired zoom location, or draw a circle, box, or other shape around an area or object of interest. Via voice-command, the user may simply instruct the user device to zoom the scene 420, which then slowly zooms until the user instructs the user device to stop or a permitted maximum zoom is achieved.

As seen in FIG. 4A the display may highlight a selection 410 made by any of the motions, taps, or interactions discussed herein. After the selection is confirmed, verified, or otherwise satisfies a visual threshold, the video stream switches from camera 360 to video output from a play station.

In an example, a player may select a particular play station shown in scene 420 by zooming in on the player device. When the player zooms in close enough that the screen of the selected player device meets a threshold, the video stream from camera 360 is stopped, and the video output from the selected player device fills device screen 440.

In some embodiments, the selection threshold may be a tap selection of the chosen play station. In other embodiments, the selection threshold occurs when the selected play station is zoomed in on to at least a certain point. For example, the camera video stream may stop and transfer to the gaming video output when the player zooms in far enough to only see the screen of the play station. In another example, the camera video stream may stop and transfer to the gaming video output when a particular section of the play station fills the user device screen 440. The particular section may be a gaming area, a screen area, a control area, or other part of the play station.

According to various aspects, the camera 360 may stream a default scene view indicative of a first field of view. The first field of view may be some or all of the gaming floor. The first field of view may be larger than a screen of any play station. When the scene 420 is adjusted to fill the screen 440 with the screen or gaming area of a selected play station, the video stream may switch from the camera to the play station. In some examples, the switch may occur when an element of the play station, e.g., screen bevels, a frame, a side portion of the play station, etc., are no longer in view on screen 440. Accordingly, the video stream switch may occur when the first field of view adjusts to a second field of view within the first field of view.

FIG. 4B illustrates play station video output 430 streamed to a player device 400. When the video stream switches from the camera 360 or image sensor to the play station video, the player can play the game directly on their device. A player may make bets, gaming selections, interactions, and other gaming input and interaction as if play were occurring live at the play station. At any time, the player may also zoom back out sufficiently to switch back to the camera video stream, which may allow the player to confirm that the player is seeing the live play even while zoomed in on the screen of the play station. The ability to switch back and forth between the camera video stream and the play station video stream creates a more secure and authentic experience for the player, as though they were truly within the live casino environment, instead of playing remotely somewhere else.

In some examples, the game may include a live dealer with an electronic table game in a pit. Similar to the layout illustrated in FIG. 3, a live event may occur in a gaming area (e.g., table 310), visible to those playing at a play station. Events occurring in the gaming area may be bet on, viewed, or otherwise interacted with at the individual play stations. In some cases, the live event may be a live dealer, a dice throw, a roulette spin, or other betting event occurring in real time.

For example, players may place bets using a wallet saved on the user device. Funds may be transferred via the wallet to the gaming application or other means to place bets similar to how bets would be made at the play station.

In some examples, one or more peripherals may be connected to the user device to enhance the gaming experience. For example, a button (e.g., “bash button”) may be connected to the user device to allow players to initiate certain gaming events by activating the button. Other types of peripherals may be applicable, based on the play station and/or game type. In some examples, the peripheral may be connected through a Universal Serial Bus (USB). In another example, a card reader may be connected to the user device, to enable users to add funds, log in, or access loyalty programs, discounts, free games, and the like.

The gaming experience and gaming interactions at the player device may occur in real time, thus providing a live gaming experience to players. This also allows players who are remote or otherwise unable to play directly on at a play station to play. The remote control of the play station, via any of the techniques discussed herein, enable more players to access the play stations. In addition to improving gaming access, the techniques also provide variety as to how games are played, which may also increase player interest, entertainment, and participation. Such improvements can further benefit the gaming location and its profitability since more players can access the games and play remotely, and the number of unoperated play stations at any given time will likely be reduced.

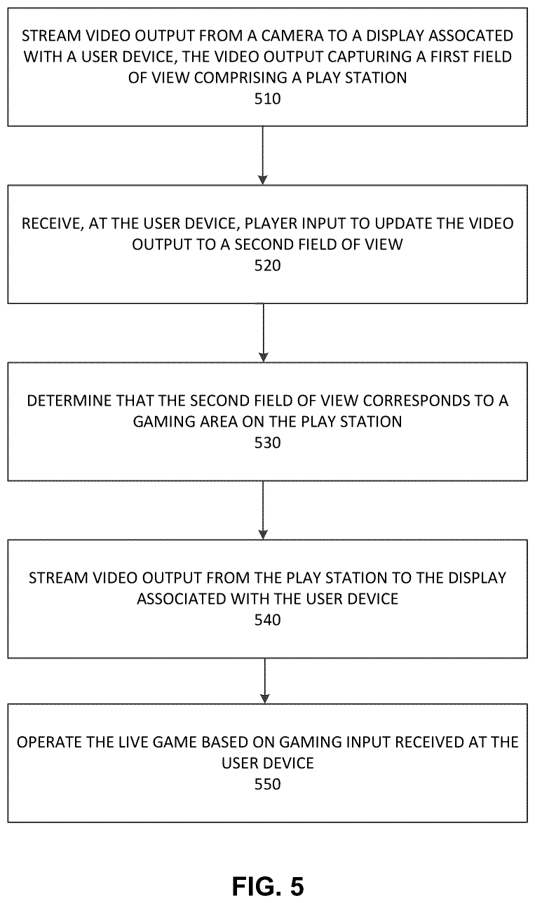

FIG. 5 provides a flowchart of a live gaming operation, in accordance with various aspects. Such operations may occur using one or more computing devices, including a processor and memory. Various techniques may utilize one or more cameras, user devices (e.g., cell phone, smartphone, PC, gaming device, etc.), play stations (e.g., an electronic table game), or applications operating on a user device or other computing device. In some examples, a user device may include a downloadable application, which provides access to the camera and play station(s) and manages one or more operations described herein. In some examples, the application may communicate with one or more remote computing devices, servers, databases, and computing elements to manage communications and operations between various devices.

At block 510, aspects may stream video output from a camera to a display associated with a user device, wherein the video output captures a first field of view comprising a play station. The field of view may correspond to a viewable region provided on a display associated with the user device. As discussed herein, the first field of view may be a gaming floor (e.g., gaming area 300), at least one play station, or other live view within a gaming location. In an example, the first field of view captures a gaming screen on the play station and a surrounding element of the play station. The surrounding element may be a screen bevel, a frame, a side portion of the play station, among others.

There may be one or more selectable regions within the first field of view. A selectable region may correspond to a gaming area on the play station. In some examples, the selectable region may be generated based on an identification of one or more objects, such as a play station, and/or a display associated with a play station, within the first field of view.

The first field of view may capture a gaming floor including a plurality of play stations, which may be selectable from the user device, as described herein, to initiate a remote gameplay operation.

At block 520, aspects may receive player input at the user device, wherein player instructions update the video output to a second field of view. The player instructions may include a tap, pinch, hold, or other motion or manipulation of the scene depicted in the first field of view. For example, the player instructions may enable a zoom in or out on various areas within or surrounding the first field of view. The player instructions may be a motion performed on the display, the motion indicative of a selection of a play station or gaming area on the play station. The motion may be a zooming motion, a circular motion, a screen tap, or a screen hold. According to some aspects, the video output on the display may update in real-time, based on the player input.

In response to player input at the user device, the first field of view may update to a second field of view. In some examples, player input may cause the user device to zoom in to a region, such as a player station or a display associated with the player station, within the first field of view. The region may be a selectable region within the first field of view.

At block 530, aspects may determine that the second field of view corresponds to a gaming area on the play station. In various examples, the second field of view displays an area within the first field of view. For example, a first field of view may be a gaming area, and the second field of view may be a play station element, such as a screen of a play station. In other examples, the second field of view may be an area adjacent to the first field of view. As discussed herein, the determination may be based on a threshold, such as a visual threshold or a selection threshold. The threshold may, for example, correspond to a size of an object or an area relative to a size of the display of the user device. A user may enlarge or zoom in on an object, such as a display of a player station, and when the player station display size reaches a threshold amount (e.g., 50%, 60%, 70%, 80%, 90%, 100%) of the user device display, the second field of view may be determined to be associated with the gaming area. In other examples, reaching the threshold may initiate a selection of a selectable region within the first field of view. Similar to the first field of view, the second field of view may provide a view of an area or an object in real time.

At block 540, aspects may stream video output from the play station to the display associated with the user device. According to various aspects, the camera video stream may be stopped upon the determination at block 530, and the play station video output may be started. In some examples, the camera video stream may be stopped upon determining that the second field of view corresponds to the gaming screen.

The video stream switch may further include transferring gameplay control from the play station to the user device. This may occur after a determination that the second field of view corresponds to the gaming area. In some examples, the play station may no longer be playable by a live player or another remote player, since its gameplay operation has been transferred to the user device.

The play station video output may correspond to a game module associated with the play station. Such video output would otherwise be provided at the play station, such as on the display associated with the play station, during gameplay by a live, in-person player. In some examples, the play station video output may be provided on both the play station and on the display associated with the user device.

At block 550, aspects may operate the live game based on gaming input received at the user device. The gaming input may correspond to gameplay on the play station and enable operation of the play station from the user device. A remote player may therefore select and play a particular play station at a gaming location without being physically present at the gaming location. Such aspects may increase player choice and entertainment by enabling players to view live streams of a gaming location, select a particular play station, and operate a live game on the play station, in real-time. Aspects may therefore simulate live gaming experiences for remote players, and provide a unique gameplay technique, which combines live, virtual, remote gameplay, with a physical gaming device. For example, the gaming input may be a selection, a command, such as a launch command, or initiation of an operation, such as a seed determination. An external controller connected to the user device may be configured to perform gameplay operations and provide gaming input. As discussed herein, the live game may be craps, roulette, blackjack, or another virtual game, or table game.

Gaming input may generate one or more commands which are communicated to the player machine, to operate the gaming machine in a same manner as a live player at the machine. As seen in FIG. 5B live gaming output may provide a live view of a gaming screen that is reflective of the game provided at the player machine. A remote player may toggle between the gaming screen and a view of the player machine, and make selections at the user device, just as a live player at the machine would. Gaming input is reflective of the particular game being played, and may include, for example, selections to deal a card, select one or more symbols on a betting layout, initiate a launch, place a bet, cash out, and the like.

In some examples, as in FIG. 5B, the live gaming output reflects a gaming screen associated with the player machine and selections at the user device are mapped to the player machine. For example, a live player could make one or more selections (e.g., bets) directly on the player machine by touching the screen. A selection at a user device may be mapped and communicated to the player machine, so that remote gameplay commands operate the machine similar to a live player operating the player machine.

To further promote a live gameplay experience, as discussed herein, a user may switch between various views, displays, and gaming output associated with the player machine. As such, as user may view live gaming output, the player machine, the gaming floor, and operate the player machine just as a player would in person.

Each of the blocks of FIG. 5 may be reversed as further discussed herein, such that when player input at the user device indicates that the video input is to be updated from the second field of view to the first field of view the video output stream reverses from the play station to the camera.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The techniques described above can be implemented on a computing device associated with a gaming device (e.g., a roulette machine operating a live roulette game), a plurality of computing devices associated with a plurality of gaming devices, a controller in communication with the gaming device(s) (e.g., a controller configured to synchronize the gaming devices(s)), or a plurality of controllers in communication with the gaming device(s). Additionally, the techniques may be distributed between the computing device(s) and the controller(s). FIG. 6 illustrates an exemplary block diagram of a computing system that includes hardware modules, software module, and a combination thereof and that can be implemented as the computing device and/or as the server.

In a basic configuration, the computing system may include at least a processor, a system memory, a storage device, input/output peripherals, communication peripherals, and an interface bus. Instructions stored in the memory may be executed by the processor to perform a variety of methods and operations, including the roulette wheel velocity adjustments and result detection optimization, as described above. The computing system components may be present in the gaming device, in a server or other component of a network, or distributed between some combinations of such devices.

The interface bus is configured to communicate, transmit, and transfer data, controls, and commands between the various components of the electronic device. The system memory and the storage device comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

The system memory and the storage device may also comprise computer readable signal media. A computer readable signal medium may include a propagated data signal with computer readable program code embodied therein. Such a propagated signal may take any of variety of forms including, but not limited to, electro-magnetic, optical, or any combination thereof. A computer readable signal medium may be any computer readable medium that is not a computer readable storage medium and that can communicate, propagate, or transport a program for use in connection with the computing system.

Further, the input and output peripherals include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals may also include a variety of sensors, such as light, proximity, GPS, magnetic field, altitude, and velocity/acceleration. RSSI, and distance sensors, as well as other types of sensors. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface and carry out other methods and operations that the user can use to provide input to the computing system and to receive an output from the computing system.

This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing system. For example, the server may generate the user interface and may transmit information related thereto to the computing device that, in turn, renders the user interface to the user. The computing device may, for example, execute a browser or an application that exposes an application program interface (API) at the server to access the user interface hosted on the server.

Finally, the communication peripherals of the computing system are configured to facilitate communication between the computing system and other computing systems (e.g., between the computing device and the server) over a communications network. The communication peripherals include, for example, a network interface controller, modem, various modulators/demodulators and encoders/decoders, wireless and wired interface cards, antenna, and the like.

The communication network includes a network of any type that is suitable for providing communications between the computing device and the server and may comprise a combination of discrete networks which may use different technologies. For example, the communications network includes a cellular network, a Wi-Fi/broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

The techniques described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile, or non-volatile storage.

In an embodiment, a method for live gaming, comprises streaming video output from a camera to a display associated with a user device, wherein the video output captures a first field of view comprising a play station, receiving, at the user device, player input to update the video output to a second field of view, wherein the second field of view is within the first field of view, determining that the second field of view corresponds to a gaming area on the play station, streaming video output from the play station to the display associated with the user device, wherein the video output from the play station corresponds to a live game, and operating the live game based on gaming input received at the user device.

In an embodiment, wherein the first field of view captures a gaming screen on the play station, and a surrounding element of the play station.

In an embodiment, wherein the first field of view captures a gaming floor comprising plurality of play stations, wherein each of the plurality of play stations are selectable, from the user device, to initiate a remote gameplay operation.

In an embodiment, further comprising, after determining that the second field of view corresponds to the gaming area, transferring gameplay control from the play station to the user device.

In an embodiment, further comprising updating, in real-time, the video output on the display based on the player input.

In an embodiment, wherein the gaming input initiates at least one of a launch command and a seed determination associated with the live game on the play station.

In an embodiment, wherein the player input comprises a motion performed on the display associated with the user device, wherein the motion is indicative of a selection of the gaming area on the play station.

In an embodiment, wherein the motion is at least one of: a zooming motion, a circular motion, or a screen tap.

An embodiment, comprising: a camera capturing a gaming area comprising a play station, a play station, an application operating on a user device, the application configured to at least: stream video output from the camera to a display associated with the user device, update the video output based on a player input received at the user device, wherein the updated video output corresponds to a region within the gaming area, determine that the region corresponds to a gaming screen on the play station, stream video output from the play station to the display associated with the user device, wherein the video output from the play station corresponds to a live game, and operate the live game based on gaming input received at the user device.

In an embodiment, wherein the user device comprises at least one of a phone, a personal computer (PC), or a gaming device.

In an embodiment, wherein the play station is an electronic table game (ETG).

In an embodiment, wherein comprising an external controller connected to the user device configured to perform gameplay operations.

In an embodiment, wherein the external controller a button connectable to the user device via a Universal Serial Bus (USB).

In an embodiment, wherein the user device and the play station are remotely located.

In an embodiment, wherein the application is further configured to stop streaming video output from the camera upon determining that the region corresponds to the gaming screen.

An embodiment, comprising a non-transitory computer-readable medium comprising instructions stored thereon that cause a computing device to at least: stream video output from a camera to a display associated with a user device, wherein the camera captures a gaming area comprising a play station, update the video output based on a player input received at the user device, wherein the updated video output corresponds to a region within the gaming area, determine that the region corresponds to a gaming screen on the play station, stream video output from the play station to the display associated with the user device, wherein the video output from the play station corresponds to a live game, and operate the live game based on gaming input received at the user device.

In an embodiment, wherein the live game is at least one of craps, roulette, blackjack, a virtual game, or a table game.

In an embodiment, wherein the player input comprises a motion performed on the display associated with the user device, wherein the motion is indicative of a selection of the gaming area on the play station.

In an embodiment, wherein the first field of view captures at least one of: the gaming screen on the play station and a surrounding element of the play station, or a gaming floor on which the play station is located.

In an embodiment, wherein the instructions further cause the computing device to: update, in real-time, the video output on the display based on the player input, and stop streaming video output from the camera upon determining that the region corresponds to the gaming screen.

In an embodiment, a method for live, remote gaming, comprises: streaming video output from a camera to a display associated with a user device, wherein the video captures a first field of view comprising a live gaming event at a gaming location; receiving, from the user device, a wager indicative of a predicted outcome of a game cycle associated with the live gaming event; initiating the game cycle based on an action performed by a player or dealer at the gaming location; streaming, in real-time, an outcome of the game cycle; and resolving the wager based on the outcome of the game cycle.

In an embodiment, further comprising, in response to input received from the user device, changing the first field of view to a second field of view, wherein the second field of view is within the first field of view.

In an embodiment, further comprising: determining that the second field of view corresponds to a gaming area on a play station; and streaming video output from the play station to the display associated with the user device, wherein the video output from the play station corresponds to the game cycle.

In an embodiment, further comprising: receiving a second wager from a second user device, and resolving the second wager based on the outcome of the game cycle.

In an embodiment, wherein the second user device is a remote user device or a local play station.

In an embodiment, wherein the action is a dice throw, a card draw, a roulette spin, or a slot spin.

In an embodiment, wherein the gaming event is at least one of a dice game, a card game, and a roulette game.

In an embodiment, further comprising: streaming live video from a second camera to the display associated with the user device, wherein the live video from the second camera captures a second field of view within the gaming location.

As previously noted, the various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terms and descriptions used above are set forth by way of illustration only and are not meant as limitations. Those skilled in the art will recognize that those and many other variations, enhancements and modifications of the concepts described herein are possible without departing from the underlying principles of the invention. The scope of the invention should therefore be determined only by the following claims and their equivalents.

What is claimed is:

1. A method for live gaming, comprising:
streaming video output from a camera to a display associated with a user device, wherein the video output captures a first field of view comprising a play station;
receiving, at the user device, player input to update the video output to a second field of view, wherein the second field of view is within the first field of view;
determining that the second field of view corresponds to a gaming area on the play station;
streaming video output from the play station to the display associated with the user device, wherein the video output from the play station corresponds to a live game; and
operating the live game based on gaming input received at the user device.

2. The method of claim 1, wherein the first field of view captures a gaming screen on the play station, and a surrounding element of the play station.

3. The method of claim 1, wherein the first field of view captures a gaming floor comprising a plurality of play stations, wherein each of the plurality of play stations are selectable, from the user device, to initiate a remote gameplay operation.

4. The method of claim 1, further comprising, after determining that the second field of view corresponds to the gaming area, transferring gameplay control from the play station to the user device.

5. The method of claim 1, further comprising updating, in real-time, the video output on the display based on the player input.

6. The method of claim 1, wherein the gaming input initiates at least one of a launch command and a seed determination associated with the live game on the play station.

7. The method of claim 1, wherein the player input comprises a motion performed on the display associated with the user device, wherein the motion is indicative of a selection of the gaming area on the play station.

8. The method of claim 7, wherein the motion is at least one of: a zooming motion, a circular motion, or a screen tap.

9. The method of claim 1, the method further comprising:
receiving, at the user device, player input to update the video output from the second field of view to the first field of view;
determining when the second field of view no longer corresponds to the gaming area on the play station; and
streaming video output from the camera to the display associated with a user device.

10. A system for live gaming, comprising:
a play station;
a camera capturing a gaming area comprising the play station;
an application operating on a user device, the application configured to at least:
stream video output from the camera to a display associated with the user device;
update the video output based on a player input received at the user device, wherein the updated video output corresponds to a region within the gaming area;
determine that the region corresponds to a gaming screen on the play station;
stream video output from the play station to the display associated with the user device, wherein the video output from the play station corresponds to a live game; and
operate the live game based on gaming input received at the user device.

11. The system of claim 10, wherein the user device comprises at least one of a phone, a personal computer (PC), or a gaming device.

12. The system of claim 10, wherein the play station is an electronic table game (ETG).

13. The system of claim 10, further comprising an external controller connected to the user device configured to perform gameplay operations.

14. The system of claim 13, wherein the external controller a button connectable to the user device via a Universal Serial Bus (USB).

15. The system of claim 10, wherein the user device and the play station are remotely located.

16. The system of claim 10, wherein the application is further configured to stop streaming video output from the camera upon determining that the region corresponds to the gaming screen.

17. The system of claim 10, wherein the application operating on the user device being further configured to at least:
receive player input to update the video output from the region within the gaming screen of the play station to the video output from the camera.

18. A non-transitory computer-readable storage medium comprising instructions stored thereon that cause a computing device to at least:
stream video output from a camera to a display associated with a user device, wherein the camera captures a gaming area comprising a play station;
update the video output based on a player input received at the user device, wherein the updated video output corresponds to a region within the gaming area;
determine that the region corresponds to a gaming screen on the play station;
stream video output from the play station to the display associated with the user device, wherein the video output from the play station corresponds to a live game; and
operate the live game based on gaming input received at the user device.

19. The non-transitory computer-readable storage medium of claim 18, wherein the live game is at least one of craps, roulette, blackjack, a virtual game, or a table game.

20. The non-transitory computer-readable storage medium of claim 18, wherein the player input comprises a motion performed on the display associated with the user device, wherein the motion is indicative of a selection of the gaming area on the play station.

21. The non-transitory computer-readable storage medium of claim 18, wherein the first field of view captures at least one of:
the gaming screen on the play station and a surrounding element of the play station; or
a gaming floor on which the play station is located.

22. The non-transitory computer-readable storage medium of claim 18, wherein the instructions further cause the computing device to:
update, in real-time, the video output on the display based on the player input; and
stop streaming video output from the camera upon determining that the region corresponds to the gaming screen.

23. A method for live, remote gaming, comprising:
streaming video output from a camera to a display associated with a user device, wherein the video captures a first field of view comprising a live gaming event at a gaming location;
receiving, from the user device, a wager indicative of a predicted outcome of a game cycle associated with the live gaming event;
initiating the game cycle based on an action performed by a player or dealer at the gaming location;
streaming, in real-time, an outcome of the game cycle; and
resolving the wager based on the outcome of the game cycle.

24. The method of claim 23, further comprising, in response to input received from the user device, changing the first field of view to a second field of view, wherein the second field of view is within the first field of view.

25. The method of claim 24, further comprising:
determining that the second field of view corresponds to a gaming area on a play station; and
streaming video output from the play station to the display associated with the user device, wherein the video output from the play station corresponds to the game cycle.

26. The method of claim 23, further comprising: receiving a second wager from a second user device, and resolving the second wager based on the outcome of the game cycle.

27. The method of claim 26, wherein the second user device is a remote user device or a local play station.

28. The method of claim 23, wherein the action is a dice throw, a card draw, a roulette spin, or a slot spin.

29. The method of claim 23, wherein the gaming event is at least one of a dice game, a card game, and a roulette game.

30. The method of claim 23, further comprising: streaming live video from a second camera to the display associated with the user device, wherein the live video from the second camera captures a second field of view within the gaming location.
